(19) United States
(12) Patent Application Publication
(10) Pub. No.: US 2013/0051244 A1
(43) Pub. Date: Feb. 28, 2013

(54) NETWORK OPTIMISATION

(71) Applicants: Gyula Bodog, Budapest (HU); Joerg Schmidt, Chandler, AZ (US); Clemens Suerbaum, Munich (DE); Deh-Min Richard Wu, Boynton Beach, FL (US)

(72) Inventors: Gyula Bodog, Budapest (HU); Joerg Schmidt, Chandler, AZ (US); Clemens Suerbaum, Munich (DE); Deh-Min Richard Wu, Boynton Beach, FL (US)

(73) Assignee: NOKIA SIEMENS NETWORKS OY, Espoo (FI)

(21) Appl. No.: 13/519,658

(22) PCT Filed: Jan. 8, 2010
(86) PCT No.: PCT/EP10/50144

§ 371 Date: Oct. 17, 2012

(51) Int. Cl. H04L 12/26

(52) U.S. Cl. 370/241.1; 370/252

(57) ABSTRACT

A SON algorithm is described in which performance targets are defined and evaluated. The evaluation of a performance target includes using or setting an evaluation period defining a time period over which the performance target is evaluated and using or setting an evaluation frequency defining how often the performance target is evaluated. The performance targets are used for optimising a configuration of a mobile telecommunication system.

The invention relates to the optimisation and management of mobile telecommunication networks.

Mobile communication networks are becoming larger and more complicated. The size of the networks makes it highly advantageous to enable many operations to be implemented with little or no human involvement.

Self-organising networks (or self-optimising networks), referred to herein as SON, are networks that are designed to be, to a large degree, configured, managed and optimised automatically.

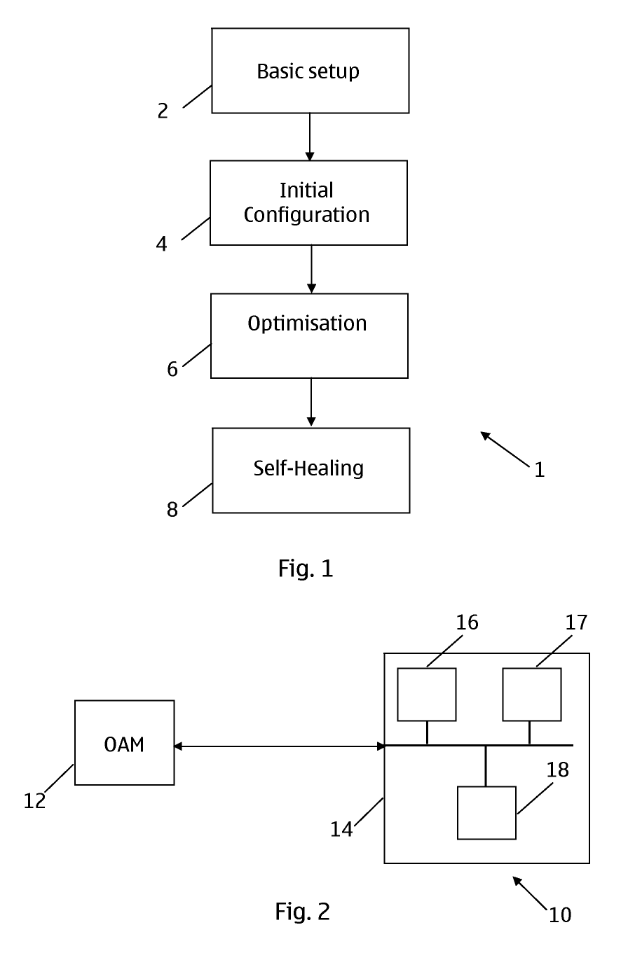

FIG. 1 is a flow chart, indicated generally by the reference numeral 1, showing an exemplary known SON algorithm. The algorithm 1 demonstrates, in very broad terms, what happens when a new node is added to a SON network.

The algorithm 1 starts at step 2, which occurs once the new node is added to the network. Step 2 is a basic setup procedure. In a mobile communication network, the step 2 may involve, for example, allocating an IP address for the new node. Next, at step 4, an initial configuration of the new node is performed. The new node typically communicates with an Operation and Maintenance (OAM) sub-system and downloads information required to automatically set a basic radio configuration.

At this stage, the new node has been configured, albeit in a sub-optimal manner. The next step, implemented at step 6 of the algorithm 1, is to optimise the setup of the new node, for example by considering the relationship between the new node and its neighbouring nodes.

Finally, the algorithm 1 includes a self-healing step 8, which step is used to monitor for faults and, in case a fault is detected, identify, diagnose and solve the fault, all, typically, without requiring human input.

When optimising mobile communication networks, SON algorithms typically change network configurations based on objectives and targets defined by a network operator. The network operator needs to be able to check if the targets are met at a rate according to his needs.

Target evaluation measurements and key performance indicators are usually defined together with related intervals, typically referred to as granularity periods. Such granularity periods are typically of the order of 15, 30 or 60 minutes, although, of course, any other granularity period would be possible.

These granularities may be too fine grained for the operator and also for the SON algorithms, which base their decision to change (or not change) configurations on measurement results.

By restricting SON algorithms to using the existing granularity periods, such algorithms can become unstable, since changes made to the network configuration are not given time to affect network performance before further adjustments are made.

The present invention seeks to address at least some of the problems outlined above.

The present invention provides a method of optimising configuration in a mobile telecommunication system, the method comprising: using and/or setting an evaluation period defining a time period over which the performance target is evaluated; using and/or setting an evaluation frequency defining how often the performance target is evaluated; and evaluating the performance target in accordance with the evaluation period and the evaluation frequency, wherein the evaluation of the performance target is used for optimising a configuration of a mobile telecommunication system. The method may be (or may form part of) a self-organising network (or self-optimising network) algorithm.

The present invention also provides an apparatus (such as an Integration Reference Point Manager and/or an Integration Reference Point Agent) comprising: means for evaluating a performance target in accordance with an evaluation period and an evaluation frequency, wherein the evaluation period defines a time period over which the performance target is evaluated and the evaluation frequency defines how often the performance target is evaluated; and means for optimising a configuration of a mobile telecommunication system depending on the evaluation of the performance target.

The present invention yet further provides a system comprising an Integration Reference Point Manager and an Integration Reference Point Agent, wherein the system is adapted to: obtain and/or set a time period over which the performance target is evaluated; obtain and/or set evaluation frequency defining how often the performance target is evaluated; and evaluate the performance target in accordance with the evaluation period and the evaluation frequency, wherein the evaluation of the performance target is used for optimising a configuration of a mobile telecommunication system.

The present invention enables the period over which decisions in a SON algorithm are taken to be adjusted, and also allows the period over which data is gathered to be adjusted. These adjustments can also, in many forms of the invention, be made independently of one another. Accordingly, the present invention provides a great deal of flexibility and addresses many of the problems discussed above.

The present invention enables a SON algorithm to be implemented in which performance targets are defined and evaluated. The evaluation of a performance target includes using or setting an evaluation period defining a time period over which the performance target is evaluated and using or setting an evaluation frequency defining how often the performance target is evaluated. The performance targets can be used for optimising a configuration of a mobile telecommunication system.

The present invention enables an IRP Manager, or a similar functional block, to control SON functionality with significantly flexibility.

Moreover, the approach of the present invention is in line with existing 3GPP OAM standards.

The measurements on which the performance target is determined may be taken in accordance with a predetermined granularity period. In some forms of the invention one or both of the evaluation period and the evaluation frequency may be set to be integer multiples of the granularity period. Typically, this is implemented by specifying either the integer or a granularity multiplier value.

In many forms of the invention, the evaluation period and/or the evaluation frequency is/are set via an Operations and Maintenance (OAM) interface.

The invention also provides a computer program comprising: code (or some other means) for using and/or setting an evaluation period defining a time period over which the performance target is evaluated; code (or some other means) for using and/or setting an evaluation frequency defining how often the performance target is evaluated; and code (or some other means) for evaluating the performance target in accordance with the evaluation period and the evaluation frequency, wherein the evaluation of the performance target is used for optimising a configuration of a mobile telecommunication system. The computer program may be a computer program product comprising a computer-readable medium bearing computer program code embodied therein for use with a computer.

Exemplary embodiments of the invention are described below, by way of example only, with reference to the following numbered drawings.

FIG. 1 is flow chart demonstrating a known SON algorithm;

FIG. 2 is a block diagram of a system in which the present invention can be used;

FIG. 3 shows a timeline demonstrating an exemplary embodiment of the present invention;

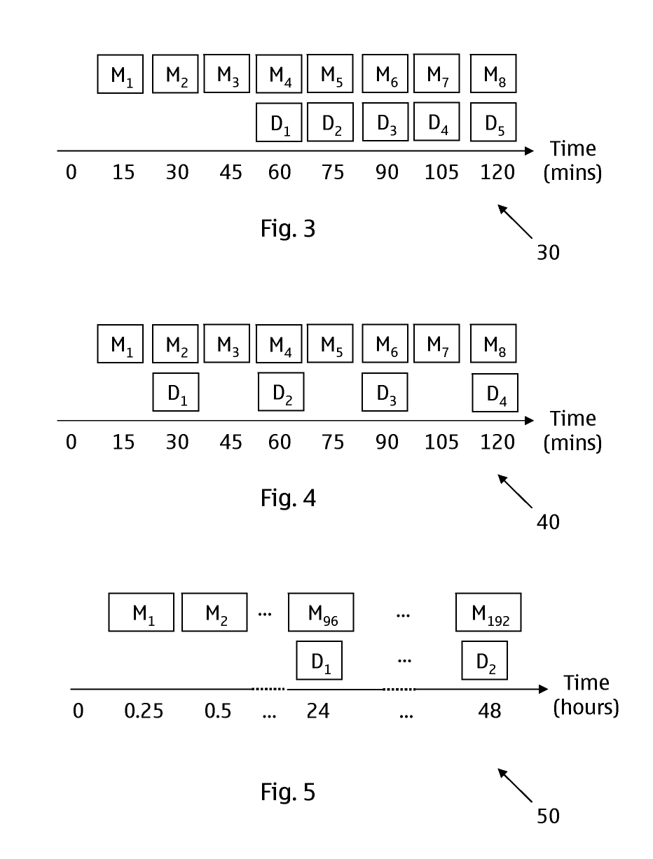

FIG. 4 shows a timeline demonstrating an exemplary embodiment of the present invention;

FIG. 5 shows a timeline demonstrating an exemplary embodiment of the present invention; and

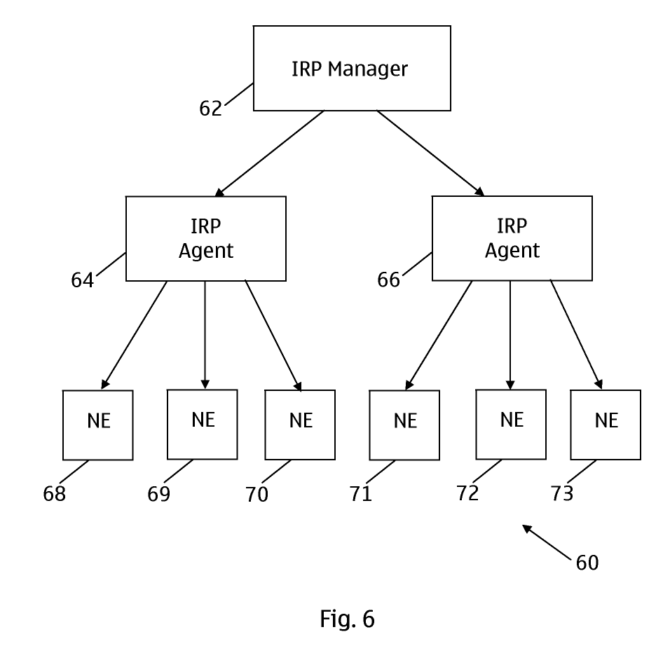

FIG. 6 is a block diagram of a system in accordance with an aspect of the present invention.

FIG. 2 is a block diagram of a mobile communication system in which the present invention can be used. The system, indicated generally by the reference numeral 10, comprises an OAM server 12 and a network 14, which network consists of a number of nodes, such as base stations. Three nodes (nodes 16, 17 and 18) are shown, but, of course, a typical mobile communication system would consist of many more nodes.

As described above with reference to FIG. 1, the OAM server 12 communicates with the nodes 16, 17 and 18. The operation of the various nodes is monitored on a regular basis and performance measurements used to adjust the configuration of the network, in order to optimise performance.

The present invention introduces two additional parameters/attributes in order to allow a network operator to adjust the period of the target evaluation interval and the frequency of that evaluation according to his requirements. These parameters/attributes are referred to herein as “targetEvaluationPeriod” and “targetEvaluationFrequency”.

The attribute targetEvaluationPeriod determines the period over which the SON algorithm shall use measurement results to evaluate the target achievement.

The attribute targetEvaluationFrequency determines how often the SON algorithm shall evaluate the target achievements.

Exemplary usages of the newly defined attributes are described below, with reference to FIGS. 3 to 5. In each case, it is assumed that the measurement granularity period of 15 minutes. Of course, other granularity periods could be used.

FIGS. 3 to 5 each show a timeline demonstrating an exemplary embodiment of the present invention. The timelines show when network measurements are taken (indicated by the reference M) and when decisions are taken (indicated by the reference D).

FIG. 3 shows a timeline, indicated generally by the reference numeral 30. In the exemplary timeline 30, the targetEvaluationFrequency attribute is set to 15 minutes such that evaluations are made every 15 minutes and the targetEvaluationPeriod attribute is set at 1 hour (60 minutes). In the exemplary timeline 30, the evaluation D₁ (at time=60 minutes) takes into account the measurement results M₁, M₂, M₃ and M₄ (at time=15, 30, 45 and 60 minutes respectively). Similarly, the evaluation D₂ (at time=75 minutes) takes into account the measurement results M₂/M₃, M₄ and M₅, the evaluation D₃ (at time=90 minutes) takes into account the measurement results M₃, M₄, M₅ and M₆ etc.

Thus, in the example of FIG. 3, a decision of the SON algorithm is taken every 15 minutes and each decision takes into account the measurement results of the past four quarters of an hour, leading to a smoothening, averaging effect.

FIG. 4 shows a timeline, indicated generally by the reference numeral 40, of another exemplary use of the present invention. The timeline 40 shows measurement being taken every 15 minutes (the defined granularity period) and evaluations being made every 30 minutes. In the timeline 40, the targetEvaluationFrequency attribute is set to 30 minutes such that evaluations are made every 30 minutes and the targetEvaluationPeriod attribute is set at 45 minutes.

In the timeline 40, the evaluation D₂ (at time=60 minutes) takes into account the measurement results M₂, M₃, and M₄ (at time=30, 45 and 60 minutes respectively) the evaluation D₃ (at time=90 minutes) takes into account the measurement results M₄, M₅ and M₆ and evaluation the evaluation D₄ (at time=120 minutes) takes into account the measurement results M₆, M₇ and M₈. The evaluation D₁ (at time=30 minutes) takes into account the measurement results M₂ and M₃, and would also take into account a measurement result M₀ (at time=0), if such a measurement existed.

Thus, in the example of FIG. 4, each decision of the SON algorithm take place every 30 minutes and take into account the measurement results over 45 minutes, leading to a moderate averaging effect of the more frequent measurements. Decisions in timeline 40 are taken less often than in the timeline 30.

FIG. 5 shows a timeline, indicated generally by the reference numeral 50, demonstrating a further exemplary use of the present invention. In the exemplary timeline 50, the targetEvaluationFrequency attribute is set to 1 day such that evaluations are made once every 24 hours and the targetEvaluationPeriod attribute is set at 1 day. Thus, a single decision of the SON algorithm is made each day, with that decision being based on the measurement data of the last day, which are available in 96 fifteen minute periods.

Of course, the timelines 30, 40 and 50 show only three exemplary embodiments of the invention. Clearly, the targetEvaluationFrequency and targetEvaluationPeriod attributes could be adjusted in many different ways that are not discussed here.

FIG. 6 is a block diagram of a system, indicated generally by the reference numeral 60, in accordance with an aspect of the present invention. The system comprises an IRP (Integration Reference Point) Manager 62, a first IRP agent 64, a second IRP agent 66, and six network elements 68 to 73. The first and second IRP agents 64 and 66 are each coupled to the IRP Manager 62. The first IRP agent 64 is also coupled to the first, second and third network elements 68, 69 and 70. The second IRP agent 66 is also coupled to the fourth, fifth and sixth network elements 71, 72 and 73.

The present invention can be implemented by enabling information controlling SON functionality to be transported via the so-called Itf-N between an IRP Manager (usually a Network Management System) and IRP agents (usually an Element Manager). A mechanism for achieving this may be set as part of the relevant 3GPP standard, but this, at present, has yet to be decided.

Two possible options for such an implementation are referred to below:

a) an interface IRP may be provided, where the controlling information is part of an operation request sent from the IRP Manager 62 to the IRPAgents 64 and 66. This operation allows the IRPManager to transport on the Itf-N interface information to control the SON functionality.

b) a network resource mode (NRM) IRP may be used, where the controlling information is modelled as object classes, with the creation of such object classes and their attribute values being managed by the IRP Manager 62. Each object class represents the information used to control the SON functionalities.

In either case, targetEvaluationPeriod and targetEvaluationFrequency are defined. However, in the first case, there would be new parameters targetEvaluationPeriod and targetEvaluationFrequency in the suitable operation, whereas, in the second case, targetEvaluationPeriod and targetEvaluationFrequency attributes would be new attributes in the suitable object class; these attributes could be managed by the operations of these object classes.

Regardless of whether there is one general object class for SON functionality control or separate object classes of this kind for each SON use case, i.e. each SON optimization functionality, the basic principles of the invention would be the same.

Consider the following generic implementation example, where “SONFunctionName” is a placeholder: In this example, it is assumed that for this SON function, the target evaluation period and frequency shall be different for all potential targets, in this example two. In this example, two pairs of attributes are needed as follows:

| Attribute Name | Definition |
|---|---|
| Target1Evaluation | This attribute identifies the period which |
| PeriodForSONFunc- | shall be used for the achievement |
| tionName | evaluation of target 1 of [SON function |
| | name]. It shall be a multiple of the |
| | minimum granularity period of the related |
| | measurements. |
| Target1Evaluation | This attribute indicates how often the |
| FrequencyForSONFunc- | achievement evaluation of target 1 of [SON |
| tionName | function name] shall be executed. |
| Target2Evaluation | This attribute identifies the period which |
| PeriodForSONFunc- | shall be used for the achievement |
| tionName | evaluation of target 2 of [SON function |
| | name]. It shall be a multiple ot the |
| | minimum granularity period of the related |
| | measurements. |
| Target2Evaluation | This attribute indicates how often the |
| FrequencyForSONFunc- | achievement evaluation of target 2 of [SON |
| tionName | function name] shall be executed. |

Consider now this application to SON function Handover Optimization. In this example, it is assumed that for Handover Optimization the target evaluation period and frequency shall be the same for all potential targets, i.e. only one pair of attributes are needed as follows.

| Attribute Name | Definition |
|---|---|
| targetEvaluationPeri- | This attribute identifies the period which |
| odForHOOptimization | shall be used for the target achievement |
| | evaluation of Hand-over optimization. It |
| | shall be a multiple ot the minimum |
| | granularity period of the related |
| | measurements. |
| targetEvaluationFre- | This attribute indicates how often the |
| quencyForHOOptimization | target achievement evaluation of Hand-over |
| | optimization shall be executed. |

In the embodiments described above, reference has been made to a single optimisation algorithm. Thus, a single targetEvaluationPeriod and a single targetEvaluationFrequency is discussed. Of course, the principles of the invention can be applied to the optimisation of many features of a mobile communication system, such as handover optimization, load balancing optimization, interference optimization, and energy saving optimization. The various optimization algorithms may have difference requirements and may therefore have different pairs of evaluation period and frequency attributes.

The term OAM has been used to refer to “Operation and Maintenance”. The term “Operation, Administration and Maintenance” is often used in the art, but the meaning of these terms is the same.

The embodiments of the invention described above are illustrative rather than restrictive. It will be apparent to those skilled in the art that the above devices and methods may incorporate a number of modifications without departing from the general scope of the invention, e.g. using specific operations to set the targetEvaluationPeriod and targetEvaluationFrequency, using other labels for parameters/attributes transporting/containing the same information, having several targetEvaluationPeriods and targetEvaluationFrequencies for several targets of the same optimization use case, using a fixed or default targetEvaluationPeriod and/or targetEvaluationFrequency etc. It is intended to include all such modifications within the scope of the invention insofar as they fall within the scope of the appended claims.

1. A method of optimising configuration in a mobile telecommunication system, the method comprising:
using and/or setting an evaluation period defining a time period over which the performance target is evaluated;
using and/or setting an evaluation frequency defining how often the performance target is evaluated; and
evaluating the performance target in accordance with the evaluation period and the evaluation frequency, wherein the evaluation of the performance target is used for optimising a configuration of a mobile telecommunication system.

2. A method as claimed in claim 1, wherein measurements on which the performance target is determined are taken in accordance with a predetermined granularity period.

3. A method as claimed in claim 2, wherein the evaluation period and/or the evaluation frequency are set to integer multiples of the granularity period.

4. A method as claimed in claim 1, wherein the method is a SON algorithm.

5. A method as claimed in claim 1, wherein the evaluation period is set via an OAM interface.

6. A method as claimed in claim 1, wherein the evaluation frequency is set via an OAM interface.

7. An apparatus comprising:
means for evaluating a performance target in accordance with an evaluation period and an evaluation frequency, wherein the evaluation period defines a time period over which the performance target is evaluated and the evaluation frequency defines how often the performance target is evaluated; and
means for optimising a configuration of a mobile telecommunication system depending on the evaluation of the performance target.

8. An apparatus as claimed in claim 7, wherein the evaluation period is set via an OAM interface.

9. An apparatus as claimed in claim 7, wherein the evaluation frequency is set via an OAM interface.

10. An apparatus as claimed in claim 7, wherein the apparatus comprises an Integration Reference Point Manager.

11. An apparatus as claimed in claim 7, wherein the apparatus comprises an Integration Reference Point Agent.

12. A system comprising an Integration Reference Point Manager and an Integration Reference Point Agent, wherein the system is adapted to:
obtain or set a period defining a time period over which the performance target is evaluated;
obtain or set an evaluation frequency defining how often the performance target is evaluated; and
evaluate the performance target in accordance with the evaluation period and the evaluation frequency, wherein the evaluation of the performance target is used for optimising a configuration of a mobile telecommunication system.

13. A system as claimed in claim 12, further comprising one or more network elements, each coupled to at least one Integration Reference Point Agent.

14. A computer program product comprising:
means for using and/or setting an evaluation period defining a time period over which the performance target is evaluated;
means for using and/or setting an evaluation frequency defining how often the performance target is evaluated; and
means for evaluating the performance target in accordance with the evaluation period and the evaluation frequency, wherein the evaluation of the performance target is used for optimising a configuration of a mobile telecommunication system.
